(19) United States
(12) Patent Application Publication
(10) Pub. No.: US 2014/0022669 A1
(43) Pub. Date: Jan. 23, 2014

(54) BASE FOR HARD DISK DRIVE, METHOD OF MANUFACTURING THE SAME AND HARD DISK DRIVE HAVING THE SAME

(71) Applicant: SAMSUNG ELECTRO-MECHANICS CO., LTD., Suwon (KR)

(72) Inventor: Il Geun JEON, Suwon (KR)

(73) Assignee: SAMSUNG ELECTRO-MECHANICS CO., LTD., Suwon (KR)

(21) Appl. No.: 13/845,060

(22) Filed: Mar. 17, 2013

(30) Foreign Application Priority Data
Jul. 19, 2012 (KR) 10-2012-0078883

(51) Int. Cl. G11B 19/20; F16M 13/02

(52) U.S. Cl. CPC G11B 19/2009; F16M 13/02
USPC 360/99.08; 248/678; 29/525

(57) ABSTRACT

Disclosed herein is a base for a hard disk drive including: a base plate formed with a motor seating part; and at least one through hole formed along an outer circumference of a seating part of the base plate and formed to axially receive a coil winding part of a stator assembly of the motor, wherein the through hole is configured of a first through groove corresponding to the coil winding part and a second through groove extending from the first through groove and formed so that a radial forming width of the second through groove from a center of the seating part is narrower than that of the first through groove. According to the preferred embodiment of the present invention, it is possible to improve and maintain the rigidity of the base while avoiding the coil winding part by structurally changing the through hole of the base.

### CROSS REFERENCE TO RELATED APPLICATION

This application claims the benefit of Korean Patent Application No. 10-2012-078883, filed on Jul. 19, 2012, entitled “Base For Hard Disk Drive, Method Of Manufacturing The Same And Hard Disk Drive Having The Same”, which is hereby incorporated by reference in its entirety into this application.

### BACKGROUND OF THE INVENTION

1. Technical Field

The present invention relates to a base for a hard disk drive, a method of manufacturing the same, and a hard disk drive having the same.

2. Description of the Related Art

Generally, a spindle motor belongs to a brushless-DC motor (BLDC) and has been prevalently used in a motor for a hard disk drive, a laser beam scanner motor for a laser printer, a motor for a floppy disk driver (FDD), a motor for an optical disk drive such as a compact disk (CD) or a digital versatile disk (DVD), and the like.

In particular, a base for a hard disk drive is provided with the foregoing spindle motor and forms an appearance thereof and is coupled with a printed circuit board. The hard disk driver is connected to a personal computer (PC) by a connector of a printed circuit board. Generally, the base of an aluminum material is manufactured by a die-casting method and then additional fine machining. However, when manufacturing the base using the die-casting method, lead time of production may be increased and thus, productivity may be degraded and separate processes after the die-casting are added and thus, a manufacturing process may be complicated. Therefore, in order to solve the problems, there is a need to manufacture the base by a press machining method in consideration of quality and productivity of a product.

In the prior art, the base is provided with a through hole so as to avoid a winding coil when a stator assembly is seated. However, an avoidance space of the winding coil of the base is formed in plural and thus, the rigidity of the base may be degraded. Further, when the avoidance space of the winding coil is machined by the press machining method, a plate thickness, and the like, around the through hole may be non-uniform and as a result, the manufacturing reliability and stability of the base may be degraded.

### SUMMARY OF THE INVENTION

The present invention has been made in an effort to provide a base for a hard disk drive, a method of manufacturing the same, and a hard disk drive having the same capable of simultaneously implementing rigidity of a base and avoidance of a coil winding part by changing a structure of a through hole of the base so as to maintain and improve the rigidity of the base, in machining a through hole for avoiding the coil winding part of the base.

According to a preferred embodiment of the present invention, there is provided a base for a hard disk drive, including: a base plate formed with a motor seating part; and at least one through hole formed along an outer circumference of a seating part of the base plate and formed to axially receive a coil winding part of a stator assembly of the motor, wherein the through hole is configured of a first through groove corresponding to the coil winding part and a second through groove extending from the first through groove and formed so that a radial forming width of the second through groove from a center of the seating part is narrower than that of the first through groove.

An axial boundary between the first through groove and the second through groove may be a step part in a vertical direction to an axial direction.

The through hole may be configured of the first through groove and the second through groove continuously formed axially downwardly and a radial width from a center of the seating part may be narrower toward the second through groove from the first through groove.

The through hole may include the first through groove and the second through groove continuously formed axially downwardly and the forming width of the first through groove may be larger than that of the second through groove.

The stator assembly may be coupled with the base plate so that the coil winding part is received in the first through groove.

According to another preferred embodiment of the present invention, there is provided a method of manufacturing a base for a hard disk drive, including: preparing a metal plate for manufacturing a base; forming a through hole penetrated in a thickness direction of the metal plate; and pressing one surface of the metal plate including the through hole in the thickness direction of the metal plate by a press jig, wherein the pressing of one surface of the metal plate by the press jig is performed to be pressed to ⅓ to ⅔ points in a thickness direction of the through hole of the metal plate.

The through hole may be configured of a first through groove and a second groove, the first through groove may be a groove formed by pressing the through hole to ⅓ to ⅔ points downwardly in a thickness direction of the through hole by the press jig, and the second through groove may extend downwardly in the thickness direction from the first through groove and may be formed to have a longitudinal narrower width than that of the first through groove.

A width of the press jig may be narrow downwardly in the thickness direction of the metal plate.

In the pressing of one surface of the metal plate downwardly in a thickness direction by the press jig, the press jig may have a width larger than the longitudinal width of the through hole presses the metal plate including the through hole axially downwardly.

The metal plate may be provided with at least one seating groove along a circular circumference so that a flat metal plate is seated with a stator assembly and the through hole may be formed in the seating groove in a thickness direction.

According to another preferred embodiment of the present invention, there is provided a hard disk drive, wherein a spindle motor seated in a seating part of a base includes: a shaft forming a rotating center of a motor; a sleeve receiving the shaft and rotatably supporting the shaft; a base having one side coupled with an outer side of the sleeve to enclose the outer side of the sleeve and having an inner side mounted with a core with which a coil winding part is formed; and a hub coupled with an axial upper portion of the shaft and having an inner side formed with a rotor magnet to correspond to the core in a radial direction by folding one portion thereof axially downwardly, and the base includes: a base plate formed with a seating part of a motor; and at least one through hole formed along an outer circumference of a seating part of the is base plate and formed to axially receive a coil winding part of a stator assembly of the motor, wherein the through hole includes a first through groove corresponding to the coil winding part and a second through groove extending from the first through groove and formed so that a radial forming width of the second through groove from a center of the seating part is narrower than that of the first through groove.

An axial boundary between the first through groove and the second through groove may be a step part in a vertical direction to an axial direction.

The through hole may include the first through groove and the second through groove continuously formed axially downwardly and a longitudinal width radially formed from a center of the seating part may be narrower toward the second through groove from the first through groove.

The stator assembly may be coupled with the base plate so that the coil winding part is received in the first through groove.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of a base for a hard disk drive according to a preferred embodiment of the present invention;

FIG. 2 is a cross-sectional view of the line A-A′ of FIG. 1;

FIG. 3 is a plan view of a stator assembly in which a coil winding part of the base for a hard disk driver according to the preferred embodiment of the present invention is formed;

FIG. 4 is a cross-sectional view of the line B-B′ of FIG. 3;

FIG. 5 is an exploded cross-sectional view of the coil winding part and a through hole of the base shown in FIG. 4;

FIGS. 6 to 10 are process diagrams of a method of manufacturing a base according to a preferred embodiment of the present invention; and

FIG. 11 is a partial cross-sectional view of a hard disk driver in which the spindle motor according to the embodiment of the present invention is included.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

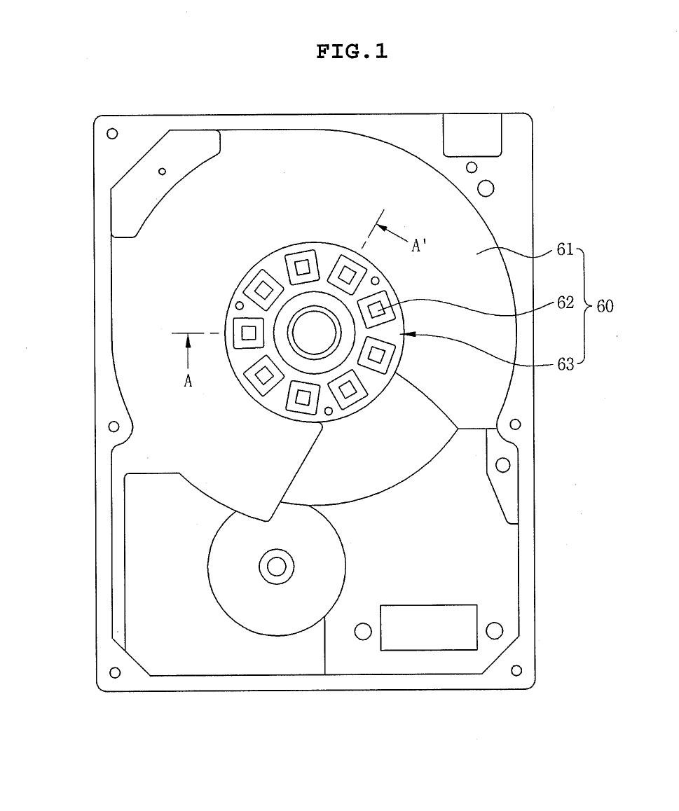

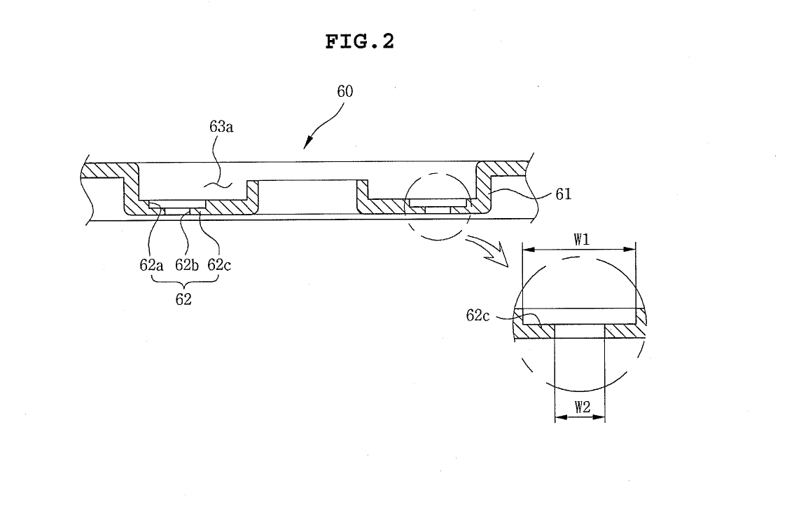

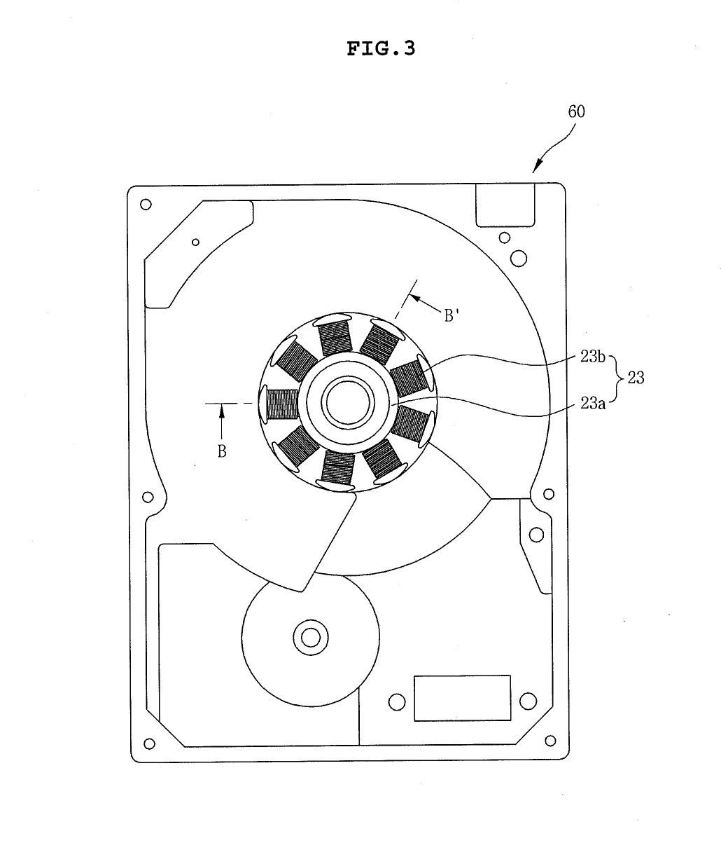

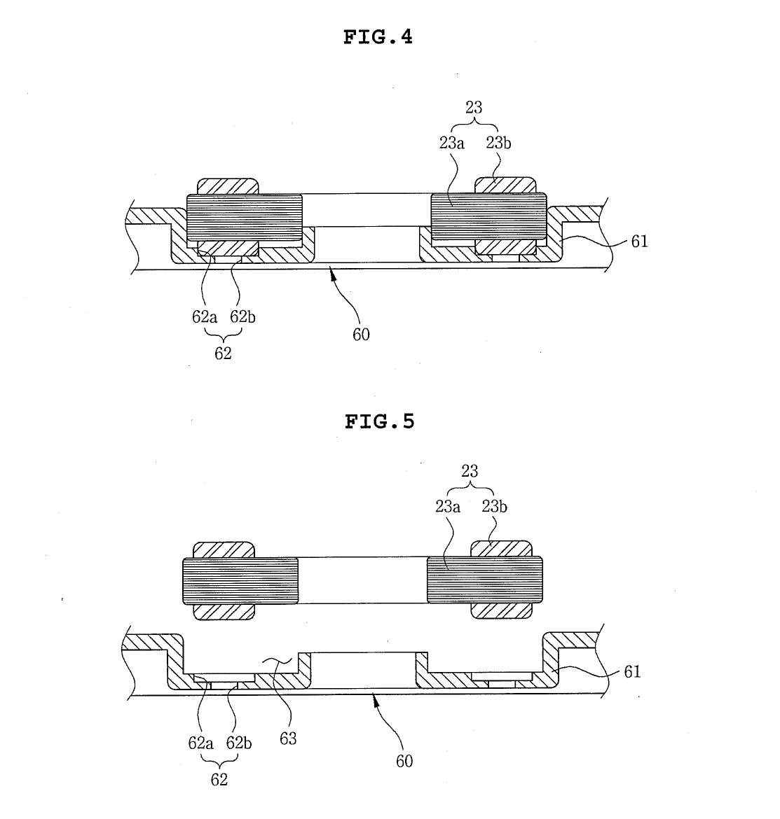

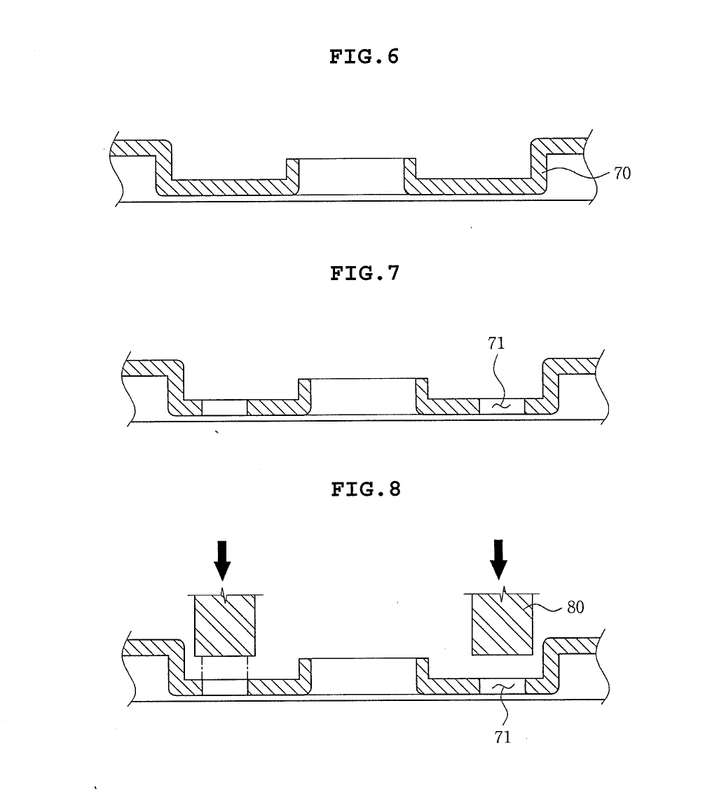

FIG. 1 is a plan view of a base 60 for a hard disk drive according to a preferred embodiment of the present invention, FIG. 2 is a cross-sectional view of the line A-A′ of FIG. 1, FIG. 3 is a plan view of a stator assembly 23 in which a coil winding part of the base 60 for a hard disk driver according to the preferred embodiment of the present invention is formed, FIG. 4 is a cross-sectional view of the line B-B′ of FIG. 3, and FIG. 5 is an exploded cross-sectional view of the coil winding part and a through hole 62 of the base 60 shown in FIG. 4.

The base 60 for a hard disk drive according to the preferred embodiment of the present invention includes a base plate 61 formed with a motor seating part 63 and at least one through hole 62 formed along an outer circumference of the seating part 63 of the base plate 61 and formed to axially receive a coil winding part 23b of the stator assembly 23 of the motor, wherein the through hole 62 may be provided with a first through groove 62a corresponding to the coil winding part 23b and a second through groove 62b extending from the first through groove 62a and formed to have a narrower width radially from a center of the seating part 63.

In particular, the preferred embodiment of the present invention relates to a structure of the through hole 62 so as to secure the avoidance space of the coil winding part 23b of the stator assembly 23 of the spindle motor in which the base 60 is seated. The thinness and miniaturization of the hard disk drive in which the spindle motor is seated may be implemented and the electrical reliability of the stator assembly 23 may be maintained, by forming the through hole 62 capable of receiving the coil winding part 23b. The present invention relates to a structure for maintaining the rigidity of the base 60 while securing the receiving space for avoiding the coil winding part 23b of the stator assembly 23 and a method of manufacturing the same and the detailed description thereof will be described below.

The base plate 61 is a flat surface on which a seating part 63 for seating the spindle motor for a hard disk drive is disposed. The base plate 61 forms an appearance in which various parts such as a spindle motor for a hard disk drive, a head assembly (not shown), and the like, are formed and may be fastened with a personal computer (PC), and the like, by a cover member (not shown). In addition, one surface of the base plate 61 is provided with a printed circuit board (not shown), which is generally used by being electrically connected with the outside. In this case, the base plate 61 may be variously formed of aluminum, aluminum alloy material, a steel plate, and the like. Further, the base 60 for a hard disk drive including the base plate 61 may be manufactured by a press machining method. As the base 60 is manufactured by the press machining, a lead time of production is saved to facilitate mass production and an additional separate machining processes are omitted to improve productivity. Further, as the process is simplified, the production cost can be saved and the quality of final product can be improved.

At least one through hole 62 is formed along an outer circumference of the seating part 63 of the base plate 61 and the coil winding part 23b of the stator assembly 23 of the motor may be to received axially downwardly. As shown in FIGS. 3 and 4, the stator assembly 23 may be coupled on the seating part 63 of the base plate 61. The through hole 62 may be formed so as to secure the avoidance space of the coil winding part 23b of the stator assembly 23 during the process of coupling the stator assembly 23 with the base plate 61.

In particular, the through hole 62 of the present invention is formed to correspond to the coil winding part 23b and may include a first through groove 62a in which the coil winding part 23b is received and a second through groove 62b extending to be penetrated in a thickness direction of the base plate 61 from the first through groove 62a. In this case, a longitudinal width W1 of the first through groove 62a may be larger than a longitudinal width W2 of the second through groove 62b. The relative widths of the first through groove 62a and the second through groove 62b are different to prevent the rigidity of the base 60 from being degraded due to the formation of the through hole 62 for receiving the coil winding part 23b. That is, the avoidance space of the coil winding part 23b is formed as the first through groove 62a to correspond to the coil winding part 23b and the remaining second through groove 62b is formed in a relatively narrower width, thereby maintaining the rigidity of the base 60. In addition, the structure is closely related to a method of manufacturing a base 60 by the press machining to be described below and the detailed description thereof will be described below.

A boundary portion vertical to an axial direction of the first through groove 62a and the second through groove 62b may be provided with a step part 62c. That is, the relative widths of the first through groove 62a and the second through groove 62b are different and thus, the step part 62c may be formed. The through hole 62 may be formed by making each width of the first through groove 62a and the second through groove 62b different, formed so that the first through groove 62a and the second through groove 62b are succeeded, and formed in a shape in which the first through groove 62a and the second through groove 62b are succeeded so that the width of the first through groove 62a and the width of the second through groove 62b are narrow axially downwardly. However, even in this case, the width of the first through groove 62a needs to be appropriately set enough to receive the coil winding part 23b.

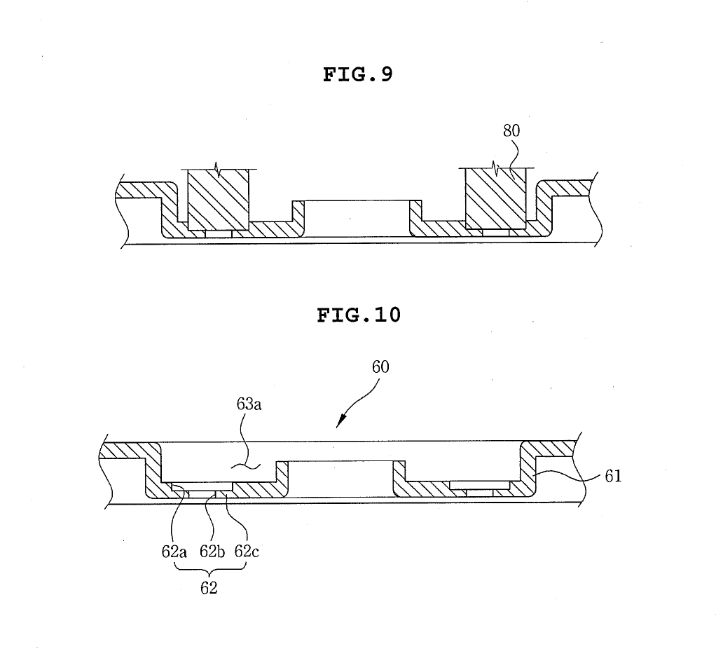

FIGS. 6 to 10 are process diagrams of a method of manufacturing a base 60 according to a preferred embodiment of the present invention.

Hereinafter, the method of manufacturing the base 60 for a hard disk drive according to the preferred embodiment of the present invention will be described below with reference to the drawings.

The method of manufacturing the base 60 for a hard disk drive according to the preferred embodiment of the present invention may include: preparing a metal plate 70 for manufacturing the base 60; forming the through hole 62 penetrated in a thickness direction of the metal plate 70; and pressing one surface of the metal plate 70 including the through hole 62 in the thickness direction of the metal plate 70 by a press jig 80, wherein the pressing of one surface of the metal plate 70 by the press jig 80 may be performed to be pressed to ⅓ to ⅔ points in a thickness direction of the through hole 62 of the metal plate 70.

As shown in FIG. 6, a metal plate 70 for manufacturing the base 60 is prepared. Here, at least one seating groove 63a may be formed by the press machining so that the metal plate 70 may be seated with the stator assembly 23. Therefore, the flat metal plate 70 may be machined by a separate machining process so that the seating groove 63a for seating the stator assembly 23 is formed by the press machining.

Next, a process of forming a cavity 71 penetrated in the thickness direction of the metal plate 70 is performed. As shown in FIG. 7, the cavity 71 is first formed to receive the coil winding part 23b of the stator assembly 23. Here, one cavity 71 having the same width is formed to be penetrated in the thickness direction of the metal plate 70.

Next, a process of pressing one surface of the metal plate 70 including the cavity 71 in the thickness direction by the press jig 80 is performed. Here, according to the preferred embodiment of the present invention, the structure of the through hole 62 may be changed to maintain the rigidity of the base 60 while receiving the coil winding part 23b of the stator assembly 23. That is, as shown in FIGS. 8 and 9, one surface of the metal plate 70 is pressed axially downwardly by the press jig 80 having a width larger than a longitudinal diameter of the cavity 71 (an arrow direction of FIG. 8). The upper portion of the through hole 62 is provided with the first through groove 62a having a width extending by the press jig 80 while the cavity 71 of the metal plate 70 is pressed by the press jig 80 and the second through groove 62b having a relatively narrower width may be naturally formed beneath the first through groove 62a since a portion of the metal plate 70 is pushed down by the press jig 80 while the first through groove 62a is formed (see FIG. 10). It is possible to prevent defects of a product due to the non-uniformity of the rigidity caused by the non-uniformity of the density of the metal plate 70 around which the through hole 62 is formed and secure the structural reliability of the base 60 for a hard disk drive, by making the widths of the through hole 62 the first through groove 62a and the second through groove 62b of the through hole 62 different by the method.

In addition, the pressing of the one surface of the metal plate 70 by the press jig 80 may be preferably performed to press ⅓ to ⅔ points in the thickness direction of the cavity 71 of the metal plate 70. That is, in order to make the relatively longitudinal widths of the first through groove 62a and the second through groove 62b different, only the portion at which the first through groove 62a is formed is pressed by the press jig 80 to entirely avoid the coil winding part 23b in the first through groove 62a and the second through groove 62b have a relatively narrower longitudinal width to maintain the rigidity of the base 60. Therefore, the diameter or the radial width of the press jig 80 are narrow axially downwardly, such that the radial width or the longitudinal width of the through hole 62 may be naturally narrow axially downwardly when the cavity 71 is pressed by the press jig 80.

The radial widths of the first through groove 62a and the second through groove 62b may be narrower in the thickness direction of the metal plate 70 while the first through groove 62a and the second through groove 62b are formed continuously, but the radial width of the first through groove 62a and the radial width of the second through groove 62b may be formed to be relatively different (the radial width of the second through groove 62b is formed to be narrower than that of the first through groove 62a). Other structures and embodiments of the through hole 62 overlap the base 60 for a hard disk drive according to the embodiment of the present invention and the detailed description thereof will be omitted.

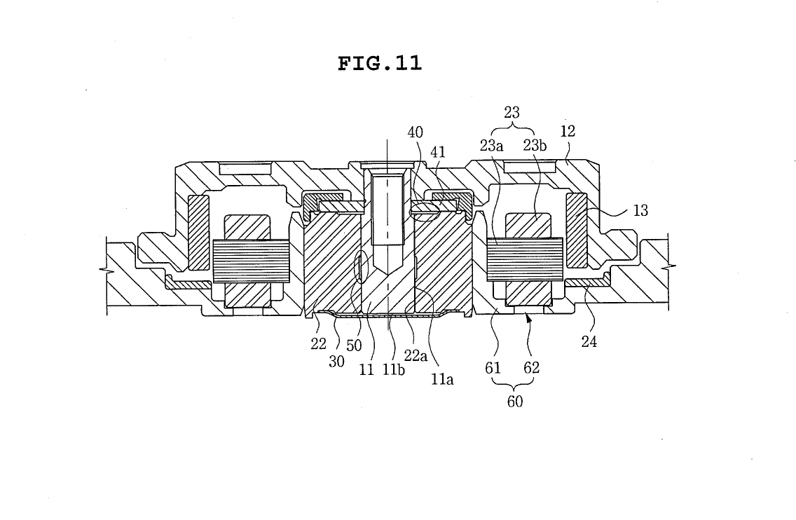

FIG. 11 is a partial cross-sectional view of a hard disk driver in which the spindle motor according to the embodiment of the present invention is included.

A hard disk driver including a spindle motor according to an embodiment of the present invention, wherein a spindle motor seated in a seating part 63 of a base 60 includes: a shaft 11 forming a rotating center of a motor; a sleeve 22 receiving the shaft 11 and rotatably supporting the shaft 11; a base 60 having one side coupled with an outer side of the sleeve 22 to enclose the outer side of the sleeve 22 and having an inner side mounted with a stator assembly 23 including a core 23a with which a coil winding part 23b is formed; and a hub 12 coupled with an axial upper portion of the shaft 11 and having an inner side formed with a rotor magnet 13 to correspond to the core 23a in a radial direction by folding one portion thereof axially downwardly, and the base 60 includes: a base plate 61 formed with a motor seating part 63; and at least one through hole 62 formed along an outer circumference of the seating part 63 of the base plate 61 and formed to axially receive a coil winding part 23b of a stator assembly 23 of the motor, wherein the through hole 62 includes a first through groove 62a corresponding to the coil winding part 23b and a second through groove 62b extending from the first through groove 62a and formed so that a radial forming width of the second through groove 62b from a center of the seating part 63 is narrower than that of the first through groove 62a.

The structure of the base 60 for the hard disk drive including the spindle motor according to the preferred embodiment of the present invention and a method of manufacturing the same will be described in advance.

Hereinafter, a configuration and an acting effect of the spindle motor seated in the base 60, along with the stator assembly 23 will be described briefly.

The shaft 11 forms a central axis on which the spindle motor rotates and is generally formed in a cylindrical shape. Here, the upper portion of the shaft 11 may be inserted with a thrust plate 41 so as to be vertical to an axial direction and the upper and lower portions of the shaft 11 may be inserted with the thrust plate 41 so as to be orthogonal to the axial direction. The thrust plate 41 may be fixed to the shaft 11 by a separate laser welding, but it is apparent to those skilled in the art that the thrust plate 41 is press-fitted to the shaft 11 by a predetermine pressure. For forming a thrust dynamic bearing part 40 by a fluid dynamic bearing, the dynamic pressure may be generated between the sleeve 22 and one surface of the facing hub 12 without the separate thrust plate 41.

The sleeve 22 is to rotatably support the shaft 11 and as shown in FIG. 11, may support the shaft so as to protrude the upper portion of the shaft 11 axially upwardly and is formed in a hollow cylindrical shape so as to insert the shaft 11 thereinto. The sleeve 22 may be formed by forging copper (Cu) or aluminum (Al) or sintering Cu—Fe-based alloy powder or SUS-based powder. The radial dynamic bearing part 50 may be formed between outer circumferential surfaces 11a of the shaft 11 facing inner circumferential surfaces 22a of the sleeve 22 by the fluid dynamic pressure. For forming the radial dynamic bearing part 50, the inner circumferential surface of the sleeve 22 facing the outer circumferential surface 11a of the shaft 11 is provided with the radial dynamic generating groove (not shown) and an actuating fluid (for example, oil, and the like) is stored between the inner circumferential surface 22a of the sleeve 22 and the outer circumferential surface 11a of the shaft 11. The radial dynamic generating groove generates the fluid dynamic pressure using the actuating fluid stored between the sleeve 22 and the shaft 11 at the time of rotating the shaft 11, thereby maintaining a non-contact state between the shaft 11 and the sleeve 22. The radial dynamic generating groove may also be formed on the outer circumferential surface 11a of the shaft 11 forming the radial dynamic bearing part 50 by the fluid dynamic pressure.

The thrust plate 41 is press-fitted in the shaft 11 so as to be orthogonal to the axial direction of the shaft 11. The thrust member 41 may be integrally formed with the shaft 11 and the separate thrust plate 41 member may be coupled therewith. As described above, the thrust plate 41 is to form the thrust dynamic bearing part 40 and the dynamic generating groove (not shown) may be formed on an axial upper surface of the thrust plate 41. The detailed description thereof overlap the above description and therefore, will be omitted herein.

One surface of the base 60 is coupled with the sleeve 22 to enclose the outer circumferential surface of the sleeve 22 so that the inner side of the base 60 is coupled with the sleeve 22 including the shaft 11. The other surface facing one surface of the base 60 is coupled so that the stator assembly 23 including the coil winding part 23b and the core 23a radially corresponds to the rotor magnet 13 mounted in the inner side thereof formed by being folded axially downwardly from the outside of the hub 12.

Meanwhile, the lower surface on which the base 60 and the sleeve 22 are bonded with each other may be provided with a conductive adhesive (not shown) for conducting the base 60 and the sleeve 22. The conductive adhesive conducts the base 60 to discharge overcharge generated at the time of the operation of the motor to the outside, thereby improving the operation reliability of the motor.

In particular, as described above, the main feature of the present invention is the very structure of the through hole 62 capable of maintaining the rigidity of the base 60 while securing the avoidance space of the coil winding part 23b of the stator assembly 23. The structural feature of the through hole 62 and the method of manufacturing the same are described above and therefore, the detailed description thereof will be omitted herein.

The core 23a of the stator assembly 23 may be generally formed by stacking a plurality of thin metal plates and is fixed to the upper portion of the base 60 on which the flexible printed circuit board (not shown) is formed. The plurality of through holes (not shown) through which the coil extracted from the coil winding part 23b of the core 23a may each be formed on the lower surface of the base 60 and the coil exposed through the through hole may be soldered to the flexible printed circuit board so as to be applied with power from the outside.

The hub 12 is to rotate an optical disk or a magnetic disk (not shown). Here, a center of the hub 12 is integrally coupled with the shaft 11 and the hub 12 is coupled with the upper portion of the shaft 11 so as to correspond to the axial upper surface of the sleeve 22. The inner side of the hub 12 is mounted with the rotor magnet 13 so as to radially face the core 23a of the base 60 to be described later. When current is applied to the core 23a, the core 23a forms a magnetic field to generate a magnetic flux. The rotor magnet 13 facing therewith is repeatedly magnetized with an N pole and an S pole in a circumferential direction to form an electrode corresponding to a variable electrode generated from the core 23a. The core 23a and the rotor magnet 13 generates a mutual repulsive force by an electromagnetic force due to the interlinkage of the magnetic flux and therefore, the hub 12 and the shaft 11 coupled therewith are rotated.

As shown in FIG. 11, the cover member 30 is coupled so as to cover the axial lower portion of the sleeve 22 including the shaft 11. The inner side of the cover member 30 facing the lower surface 11b of the shaft 11 is provided with the dynamic generation groove (not shown) to form the thrust dynamic bearing part. The cover member 30 is coupled with the end of the sleeve 22 to store the actuating fluid, oil therein.

The configuration and the operation of the spindle motor according to the embodiment of the present invention will be described briefly with reference to FIG. 11.

A rotor 10 may be configured of the shaft 11 that is rotating shaft and rotatably formed and the hub 12 attached with the rotor magnet 13 and a stator 20 may be configured of the stator assembly 23 including the base 60, the sleeve 22, the core 23a, and the coil winding part 23b and a pulling plate 24. The positions facing the outside of the base 60 and the inside of the hub 12 are each attached with the core 23a and the rotor magnet 13, wherein when current is applied to the core 23a, the core 23a forms a magnetic field to generate a magnetic flux. The rotor magnet 13 facing the core 23a is repeatedly magnetized with an N pole and an S pole to form an electrode corresponding to a variable electrode generated from the core 23a. The core 23a and the rotor magnet 13 generates a mutual repulsive force by an electromagnetic force due to the interlinkage of the magnetic flux and therefore, the hub 12 and the shaft 11 coupled therewith are rotated, thereby driving the spindle motor according to the present invention. In addition, in order to prevent the motor from floating at the time of the driving of the motor, the base 60 is provided with the pulling plate 24 so as to axially correspond to the rotor magnet 13. The attraction is applied between the pulling plate 24 and the rotor magnet 13, thereby implementing the stable rotation driving.

According to the preferred embodiments of the present invention, it is possible to to improve the machining reliability of the base by the press machining, in forming the through hole for avoiding the coil winding part.

Further, it is possible to improve and maintain the rigidity of the base while avoiding the coil winding part by structurally changing the through hole of the base.

In addition, it is possible to improve the machining reliability by the press machining by forming the through hole of the base in the stair structure in which the step parts are formed.

Further, it is possible to maintain the rigidity of the base by forming the through hole of the base in the stair structure in which the step parts are formed.

Further, it is possible to improve the productivity of the hard disk drive including the base by improving the machining easiness and reliability by the press machining by structurally changing the through hole of the base.

Further, it is possible to improve the driving reliability and the operating performance of the motor by improving the electrical reliability of the spindle motor seated on the base while securing the avoidance space of the coil winding part due to the through hole of the base.

Although the preferred embodiments of the present invention have been disclosed for illustrative purposes, they are for specifically explaining the present invention. Therefore, a base for a hard disk drive, a method of manufacturing the same, and a hard disk drive having the same according to the preferred embodiments of the present invention are not limited thereto, but those skilled in the art will appreciate that various modifications and alteration are possible, without departing from the scope and spirit of the invention as disclosed in the accompanying claims.

Accordingly, such modifications and alterations should also be understood to fall within the scope of the present invention. A specific protective scope of the present invention could be defined by accompanying claims.

What is claimed is:

1. A base for a hard disk drive, comprising:
a base plate formed with a motor seating part; and
at least one through hole formed along an outer circumference of a seating part of the base plate and formed to axially receive a coil winding part of a stator assembly of the motor,
wherein the through hole is configured of a first through groove corresponding to the coil winding part and a second through groove extending from the first through groove and formed so that a radial forming width of the second through groove from a center of the seating part is narrower than that of the first through groove.

2. The method as set forth in claim 1, wherein an axial boundary between the first through groove and the second through groove is a step part in a vertical direction to an axial direction.

3. The method as set forth in claim 1, wherein the through hole is configured of the first through groove and the second through groove continuously formed axially downwardly and a radial width from a center of the seating part is narrower toward the second through groove from the first through groove.

4. The method as set forth in claim 1, wherein the through hole includes the first through groove and the second through groove continuously formed axially downwardly and the forming width of the first through groove is larger than that of the second through groove.

5. The method as set forth in claim 1, wherein the stator assembly is coupled with the base plate so that the coil winding part is received in the first through groove.

6. A method of manufacturing a base for a hard disk drive, comprising:
preparing a metal plate for manufacturing a base;
forming a through hole penetrated in a thickness direction of the metal plate; and
pressing one surface of the metal plate including the through hole in the thickness direction of the metal plate by a press jig,
wherein the pressing of one surface of the metal plate by the press jig is performed to be pressed to ⅓ to ⅔ points in a thickness direction of the through hole of the metal plate.

7. The method as set forth in claim 6, wherein the through hole is configured of a first through groove and a second groove, the first through groove is a groove formed by pressing the through hole to ⅓ to ⅔ points downwardly in a thickness direction of the through hole by the press jig, and the second through groove extends downwardly in the thickness direction from the first through groove and is formed to have a longitudinal narrower width than that of the first through groove.

8. The method as set forth in claim 6, wherein a width of the press jig is narrow downwardly in the thickness direction of the metal plate.

9. The method as set forth in claim 6, wherein in the pressing of one surface of the metal plate downwardly in a thickness direction by the press jig, the press jig has a width larger than the longitudinal width of the through hole presses the metal plate including the through hole axially downwardly.

10. The method as set forth in claim 6, wherein the metal plate is provided with at least one seating groove along a circular circumference so that a flat metal plate is seated with a stator assembly and the through hole is formed in the seating groove in a thickness direction.

11. A hard disk drive, wherein a spindle motor seated in a seating part of a base includes:
a shaft forming a rotating center of a motor;
a sleeve receiving the shaft and rotatably supporting the shaft;
a base having one side coupled with an outer side of the sleeve to enclose the outer side of the sleeve and having an inner side mounted with a core with which a coil winding part is formed; and
a hub coupled with an axial upper portion of the shaft and having an inner side formed with a rotor magnet to correspond to the core in a radial direction by folding one portion thereof axially downwardly, and
the base includes:
a base plate formed with a seating part of a motor; and
at least one through hole formed along an outer circumference of a seating part of the base plate and formed to axially receive a coil winding part of a stator assembly of the motor,
wherein the through hole includes a first through groove corresponding to the coil winding part and a second through groove extending from the first through groove and formed so that a radial forming width of the second through groove from a center of the seating part is narrower than that of the first through groove.

12. The hard disk drive as set forth in claim 11, wherein an axial boundary between the first through groove and the second through groove is a step part in a vertical direction to an axial direction.

13. The hard disk drive as set forth in claim 11, wherein the through hole is configured of the first through groove and the second through groove continuously formed axially downwardly and a longitudinal width radially formed from a center of the seating part is narrower toward the second through groove from the first through groove.

14. The hard disk drive as set forth in claim 11, wherein the stator assembly is coupled with the base plate so that the coil winding part is received in the first through groove.
